(19) United States
(12) Patent Application Publication
(10) Pub. No.: US 2008/0091866 A1
(43) Pub. Date: Apr. 17, 2008

(54) Maintaining forward progress in a shared L2 by detecting and breaking up requestor starvation

(75) Inventors: Jason A. Cox, Raleigh, NC (US); Eric F. Robinson, Raleigh, NC (US); Thuong Q. Truong, Austin, TX (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/548,831

(22) Filed: Oct. 12, 2006

(51) Int. Cl. G06F 13/14

(52) U.S. Cl. 710/243

(57) ABSTRACT

A system having a plurality of arbitration levels for detecting and breaking up requester starvation, the system including: a plurality of logic circuits, each of the plurality of logic circuits permitted to access a cache via a plurality of requesters for requesting information from the cache; a counter for counting a number of times each of the plurality of requesters of each of the plurality of logic circuits has successfully accessed one or more of the plurality of arbitration levels and has been rejected by a subsequent arbitration level; wherein if the counter reaches a predetermined threshold for a requester of a logic circuit, the counter triggers an event that increases a priority level of the requester compared to all other requesters attempting to access the cache, so that the requestor reaches the cache before the other requesters.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to logic circuits and cache, and particularly to a method for detecting and breaking up requestor starvation between a logic circuit and a cache.

2. Description of Background

Nearly every modern logic circuit (e.g., a microprocessor) employs a cache whereby some instructions and/or data are kept in storage that is physically closer and more quickly accessible than from main memory. These are commonly known as Level 1 or L1 caches.

In the case of instructions, an L1 cache contains a copy of what is stored in the main memory. As a result, the logic circuit is able to access those instructions more quickly than if it were to have to wait for memory to provide for such instructions. Like instructions, in the case of data, an L1 cache contains a copy of what is stored in the main memory. However, some L1 designs allow the L1 data cache to sometimes contain a version of the data that is newer than what may be found in main memory. This is referred to as a store-in or write-back cache because the newest copy of the data is stored in the cache and because it is written back out to the memory when that cache location is desired to hold different pieces of data.

Also common among modern microprocessors is a second level cache (i.e., L2 or L2 cache). An L2 cache is usually larger and slower than an L1 cache, but is smaller and faster than memory. So when a processor attempts to access an address (i.e., an instruction or piece of data) that does not exist in its L1 cache, it tries to find the address in its L2 cache. The processor does not typically know where the sought after data or instructions are coming from, for instance, from L1 cache, L2 cache, or memory. It simply knows that it's getting what it seeks. The caches themselves manage the movement and storage of data/instructions.

In some systems, there are multiple processors that each have an L1 and that share a common L2 among them. This is referred to as a shared L2. Because such an L2 may have to handle several read and/or write requests simultaneously from multiple processors and even from multiple threads within the same physical processor, a shared L2 cache is usually more complex than a simple, private L2 cache that is dedicated to a single processor.

In a system with an L2 cache shared amongst multiple processors, at some point there is arbitration to determine which of the processors is allowed to access the cache (e.g., to store instructions/data to the cache). If the system has multiple levels of arbitration amongst the cache access requesters (e.g., stores, loads, snoops, etc.) then these levels of arbitration could contribute to a variety of starvation scenarios. Starvation occurs when one requestor is unable to make forward progress for some reason while other requesters continue to function. For instance, if the stores from one processor continue to lose arbitration while other processors are able to continue making forward progress, then there needs to be a way to ensure that no processor is left behind.

Specifically, an implementation is assumed where two processors share an L2 cache and there are two levels of arbitration for stores. The first level is arbitration between the store queues of two processors, and the second level is arbitration between store requests and other cache accesses. The first order starvation issue (e.g., STQ (store queue) vs. STQ) is easily fixed by guaranteeing a round-robin-type prioritization amongst the store requestors. The second order starvation issue is much more complex. The likelihood of starvation is increased when: (a) Store queue (STQa) loses second level arbitration after winning its first level arbitration verses the other STQs or (b) STQa wins the second level arbitration but is subsequently rejected for some reason such as a hazard or resource unavailability.

For example, consider the following sequence: (1) STQa wins STQ arb, (2) STQa wins general arb, (3) STQb wins STQ arb, (4) STQa is rejected, (5) STQb wins general arb, (6) STQb is not rejected, (7) STQa wins STQ arb, (8) STQa wins general arb, and (9) STQa is rejected (e.g., if STQb either directly or indirectly caused STQa to be rejected). This sequence of events could repeat over and over again, thus resulting in STQb getting all the cache bandwidth and STQa not getting any bandwidth. As a result, STQb is making progress, but STQa is not making progress, instead it is being “starved” of its ability to write the cache. With additional processors and threads sharing the same cache and with the increased snoop traffic of a system employing multiple shared L2 caches, this issue becomes more frequent.

One possible solution is to continue to request the same store once it wins arbitration. That guarantees that if one processor cannot make store progress, no other processors make progress. Eventually, all of the processors stop making L2 requests and the selected store is able win arbitration. However, this results in performance degradation because this would stop forward progress for all the other processors which would otherwise be able to make some forward progress.

Another possible solution is to leave things alone and keep a normal round-robin arbitration in place with the hope that, eventually, the store stream to STQb ends or changes in such a way as to enable STQa to make forward progress. This is not an unrealistic expectation. However, it causes issues in the performance of the processor(s) driving STQa (e.g., as the queue fills, the processor(s) are unable to generate new store traffic to place in the queue).

Considering the limitations of requestor starvation, it is desirable, therefore, to formulate a method for detecting and breaking up requestor starvation between a logic circuit and a cache.

### SUMMARY OF THE INVENTION

The shortcomings of the prior art are overcome and additional advantages are provided through the provision of a system having a plurality of arbitration levels for detecting and breaking up requestor starvation, the system comprising: a plurality of logic circuits, each of the plurality of logic circuits permitted to access a cache via a plurality of requesters for requesting information from the cache; and a counter for counting a number of times each of the plurality of requestors of each of the plurality of logic circuits has successfully accessed one or more of the plurality of arbitration levels and has been rejected by a subsequent arbitration level; wherein if the counter reaches a predetermined threshold for a requester of a logic circuit, the counter triggers an event that increases a priority level of the requester compared to all other requesters attempting to access the cache, so that the requester reaches the cache before the other requesters; and wherein once the requester reaches the cache, the priority level of the requestor is decreased to a predetermined lower priority level.

The shortcomings of the prior art are overcome and additional advantages are provided through the provision of a method for detecting and breaking up requester starvation in a system having: a plurality of arbitration levels, a plurality of logic circuits, each of the plurality of logic circuits permitted to access a cache via a plurality of requesters for requesting information from the cache; and a counter for counting a number of times each of the plurality of requestors of each of the plurality of logic circuits has successfully accessed one or more of the plurality of arbitration levels and has been rejected by a subsequent arbitration level, the method comprising: detecting queue starvation when the counter reaches a predetermined threshold for a requester of a logic circuit, by allowing the counter to trigger an event that increases a priority level of the requester compared to all other requesters attempting to access the cache, so that the requester reaches the cache before the other requesters; and decreasing the priority level of the requester to a predetermined lower priority level once the requester reaches the cache.

Additional features and advantages are realized through the techniques of the present invention. Other embodiments and aspects of the invention are described in detail herein and are considered a part of the claimed invention. For a better understanding of the invention with advantages and features, refer to the description and the drawings.

### TECHNICAL EFFECTS

As a result of the summarized invention, technically we have achieved a solution that provides for a method for detecting and breaking up requester starvation.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic diagram illustrating one example of an N queue system where there is one request for Stage 1 arbitration per queue, and then a variety of requests for Stage 2 arbitration;

FIG. 2 is a system diagram illustrating one example of detecting and breaking up of the requestor starvation process; and

FIG. 3 is a flowchart illustrating one example of detecting and breaking up of the requester starvation process.

### DETAILED DESCRIPTION OF THE INVENTION

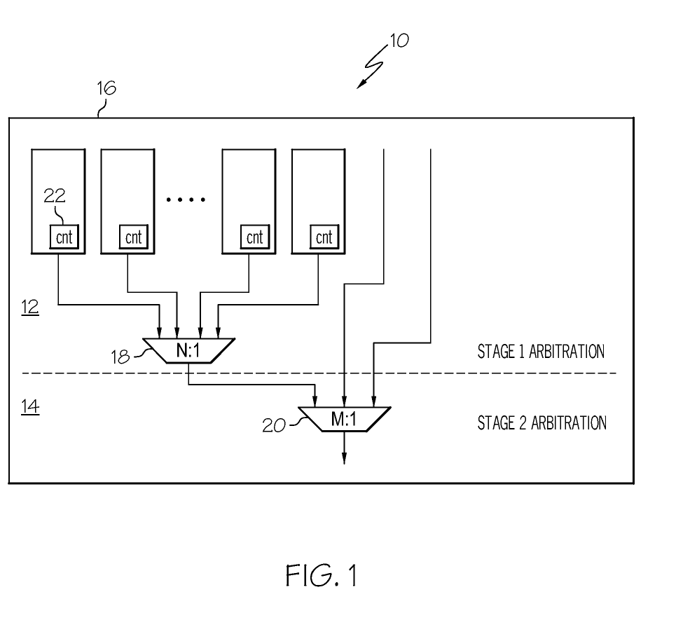

One aspect of the exemplary embodiments is a method for detecting and breaking up requester starvation. The exemplary embodiments of the present invention maintain the arbitration based on a standard round-robin scheme, and in addition detect when a queue starvation scenario may be occurring. It is noted that this need not apply only to store requestors, but may be employed by one skilled in the art for a number of different requesters. In general, when a queue starvation is detected, the arbitration scheme is modified such that the priority of the queue being starved is made higher than the priority of the other requesters into the arbitration logic. Once the queue with higher priority is able to make some forward progress, its priority drops to the normal level and arbitration then reverts back to the standard round-robin scheme. FIGS. 1-3 described below illustrate how the exemplary embodiments detect and break up requestor (e.g., store and/or load) starvation.

FIG. 1 illustrates an example of an N queue system 10 where there is one request for stage one arbitration 12 per queue, and then a variety of requests for stage two arbitration 14. In particular, N queue system 10 includes two arbitration stages; stage one arbitration 12 and stage two arbitration 14. Stage one arbitration 12 includes a plurality of queues 16 that feed a mux 18. Stage two arbitration 14 includes a mux 20 being fed by the mux 18 of stage one arbitration 12, and from a plurality of queues (not shown), which have bypassed stage one arbitration 12. In the system 10, the exemplary embodiments of the present invention have one counter 22 per arbitration requester. Counter 22 is incremented whenever its stage one request won arbitration and then was rejected due to lost stage two arbitration or perhaps detection of a hazard. The round-robin arbitration continues rotating through the stage one requests. If the request successfully proceeds past the possibility of rejection, then counter 22 is reset. When counter 22 reaches its threshold, there is a signal that is turned on to bias the arbitration to select this requester over the other requesters. This signal effectively blocks all other requests until the request is able to pass the point of rejection. Therefore, the exemplary embodiments detect when a starvation scenario occurs by assigning priority levels to requests (or queues) that want to access the cache of a system. However, the priority assigned to a queue is dynamic, in that it diminishes after the queue with the higher priority has made progress.

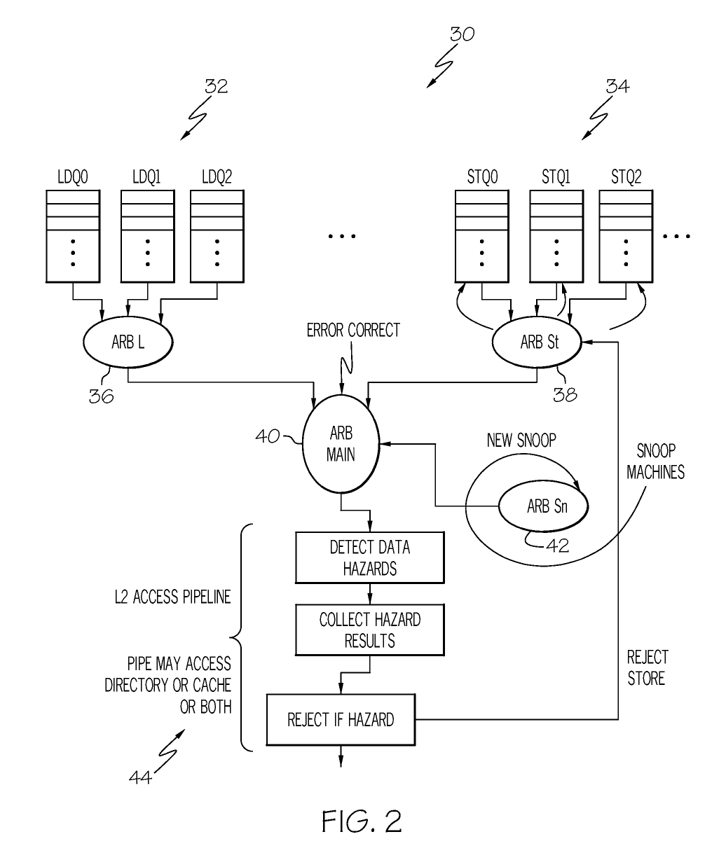

Referring to FIG. 2, there is shown a schematic diagram of a system 30 illustrating one example of detecting and breaking up of the requestor starvation process. The system 30 includes two sets of queues, load queues 32 and store queues 34. The load queues 32 provide their output to a load arbitration level 36. The store queues 34 provide their output to a store arbitration level 38. The queues in the load arbitration level 36, the store arbitration level 38, and the snoop arbitration level 42 are sent to a main arbitration level 40. The output of the main arbitration level 40 is provided to an L2 access pipeline 44, which includes the functions detect data hazards, collect hazard results, and reject if hazard is detected. For store requests, the output of the L2 access pipeline 44 is fed to the store arbitration level 38. If a store is rejected, the starvation detection counter 22 for the originating queue is incremented. If a store is not rejected, the starvation detection counter 22 for the originating queue is reset and the store is allowed to complete.

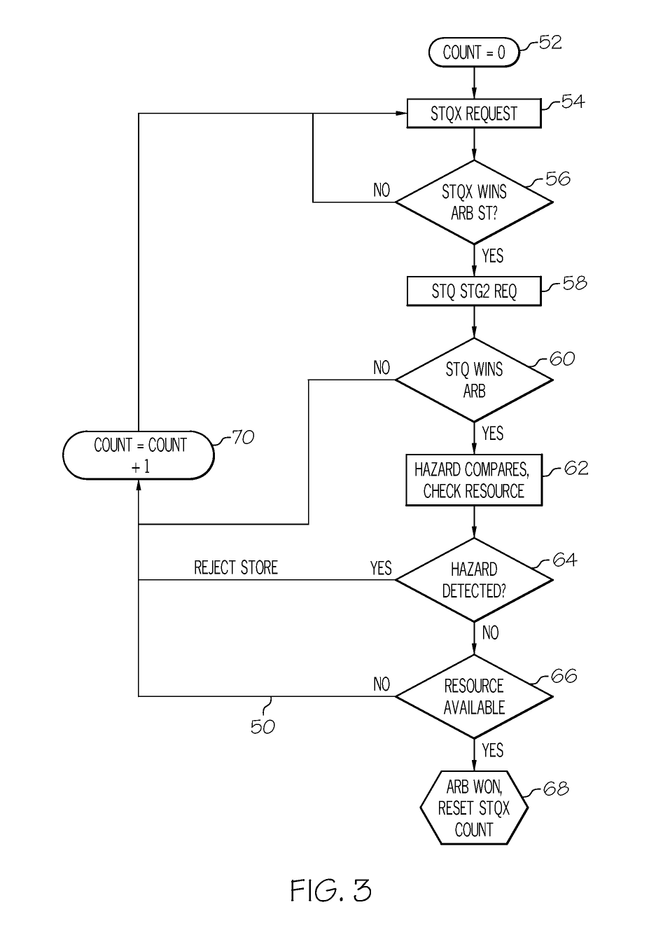

Referring to FIG. 3, there is shown a flowchart illustrating one example of detecting and breaking up of the requester starvation process. The requester starvation process flowchart 50 includes the following steps. In step 52, the counter is set to zero. In step 54, a STQX request is made to the store arbiter 38. In step 56, it is determined whether the STQX requester wins a store arbitration. If the STQX requester does not win a store arbitration, the process flows to step 54. If the STQX requester does win store arbitration, then the process flows to step 58. In step 58, a stage two STQ request is made to the main arbiter 40. The stage two STQ request is the STQX request that won arbitration at the first level, the first level being the store arbitration level in this example. In step 60, it is determined whether the stage two STQ request has won arbitration at the second level. If the stage two STQ request has not won arbitration, then the process flows to step 70. If the stage two STQ request has won arbitration, the process flows to step 62. In step 62, the process flows to the L2 access pipeline where data hazards are detected, where hazard results are collected, and where the hazard may cause the request to be rejected. In step 64, it is determined if a hazard has been detected. If a hazard has been detected, the process flows to step 70. In step 70, the starvation detection counter 22 for STQX is incremented. Once the threshold for the counter has been reached, a high priority signal is sent with the request, which improves the likelihood of STQX winning both at the store arbitration level 38 and at the main arbitration level 40, shown in FIG. 2. The rejection of the store occurs because even though the store won both arbitrations (i.e., store arbitration (stage one) and main arbitration (stage two)), it was blocked due to some other active operation. As a result, the store is rejected and its store starvation detection counter 22 is incremented. If a hazard has not been detected in step 64, the process flows to step 66. In step 66, it is determined if resources are available. If resources are not available, the process flows to step 70. If resources are available, then the process flows to step 68. In step 68, since the arbitration has been won at both levels (store arbitration level 38 and at the main arbitration level 40), the counter 22 is reset.

Concerning the threshold, it could be set one of a variety of ways. For instance, it could be a static number, determined by the implementer, a user-set value, or a randomly set value, which changes completely independent of the operation of the machine. If it was the random number, a user or the implementer would probably choose a range that it could randomly change between.

In the case where multiple of a similar queue (both requesting to the same stage 1 arbiter) both get the raised priority level, arbitration between those high-priority queues is round-robin in nature. If the case arises where multiple stage 2 requesters both have raised priority requests, in most cases, the non-priority based arbitration scheme is used to choose among the high-priority requesters. So, for instance, if a LDQ and a STQ both have high-priority requests, and in a regular scenario, loads always beat stores, then high-priority loads beat high-priority stores.

As a result, the exemplary embodiments of the present invention employ a counter that counts the number of times a store from a particular processor has won arbitration but subsequently gotten rejected for some reason. Once the counter reaches a certain threshold, it triggers an event that increases the priority of that queue's stores versus other arbitration requesters. This signal remains on until that queue wins arbitration and gets past the point of being rejected. The advantage of the exemplary embodiments is that performance degradation due to blocking out the other queues is only temporary. The case only arises when the store's starvation is starting to occur. At all other times, the arbiters are able to perform as normal. Therefore, it has the throughput advantages of a round-robin arbiter with the forward progress guarantee of a static priority-based arbiter.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system having a plurality of arbitration levels for detecting and breaking up requestor starvation, the system comprising:
a plurality of logic circuits, each of the plurality of logic circuits permitted to access a cache via a plurality of requestors for requesting information from the cache; and
a counter for counting a number of times each of the plurality of requesters of each of the plurality of logic circuits has (i) successfully accessed one or more of the plurality of arbitration levels and (ii) has been rejected by a subsequent arbitration level;
wherein, in the event the counter reaches a predetermined threshold for a requestor of a logic circuit, the counter triggers an event that increases a priority level of the requestor compared to other requestors attempting to access the cache, so that the requester is more likely to reach the cache before the other requesters; and
wherein once the requestor reaches the cache, the priority level of the requestor is decreased to a predetermined lower priority level.

2. The system of claim 1, wherein the threshold is a static number set by an implementer.

3. The system of claim 1, wherein the threshold is a user-set value.

4. The system of claim 1, wherein the threshold is a randomly set value.

5. A method for detecting and breaking up requester starvation in a system having: a plurality of arbitration levels, a plurality of logic circuits, each of the plurality of logic circuits permitted to access a cache via a plurality of requestors for requesting information from the cache; and a counter for counting a number of times each of the plurality of requestors of each of the plurality of logic circuits has successfully accessed one or more of the plurality of arbitration levels and has been rejected by a subsequent arbitration level, the method comprising:
detecting queue starvation when the counter reaches a predetermined threshold for a requester of a logic circuit, by allowing the counter to trigger an event that increases a priority level of the requester compared to other requesters attempting to access the cache, so that the requester is more likely to reach the cache before the other requesters; and
decreasing the priority level of the requester to a predetermined lower priority level once the requester reaches the cache.

6. The method of claim 5, wherein the threshold is a static number set by an implementer.

7. The method of claim 5, wherein the threshold is a user-set value.

8. The method of claim 5, wherein the threshold is a randomly set value.
